(19) United States
(12) Patent Application Publication
(10) Pub. No.: US 2014/0153249 A1
(43) Pub. Date: Jun. 5, 2014

(54) Bulb-Type LED Lamp

(71) Applicant: Toshiba Lighting & Technology Corporation, Yokosuka-shi (JP)

(72) Inventors: Takeshi Hisayasu, Yokosuka-shi (JP); Hiroshi Kubota, Yokosuka-shi (JP); Shinji Nakata, Yokosuka-shi (JP); Makoto Sakai, Yokosuka-shi (JP); Hiroshi Takenaga, Yokosuka-shi (JP)

(73) Assignee: Toshiba Lighting & Technology Corporation, Yokosuka-shi (JP)

(21) Appl. No.: 14/173,251

(22) Filed: Feb. 5, 2014

Related U.S. Application Data
(63) Continuation of application No. PCT/JP2011/071606, filed on Sep. 22, 2011.

(51) Int. Cl. F21V 3/02; F21K 99/00

(52) U.S. Cl. CPC F21V 3/02; F21K 9/30
USPC 362/294; 362/311.02

(57) ABSTRACT

An LED lamp according to an embodiment includes an LED module, a base body, a first globe, a second globe and a light guide body. In the LED module, a plurality of LEDs are mounted on a substrate. The base body holds the LED module. The first globe is arranged to surround the outer circumference of the substrate. A bore diameter (D2) of a first joining end is larger than a bore diameter (D1) of an attachment section. The second globe includes a second joining end attached to the first joining end and covers the emission side of the LEDs. A proximal end of the light guide body is fixed to a side where the LEDs are arranged. A distal end section of the light guide body has a diameter larger than the bore diameter (D1) of the attachment section of the first globe.

### CROSS-REFERENCE TO RELATED APPLICATION(S)

This application is a continuation of International Application No. PCT/JP2011/071606, filed on Sep. 22, 2011, the entire contents of which are incorporated herein by reference.

### FIELD

Embodiments described herein relate generally to a bulb-type LED lamp including a cap for a bulb.

### BACKGROUND

According to the improvement of light-emitting efficiency, a light-emitting diode (LED) has been adopted for a luminaire. Instead of an incandescent lamp including a filament as a light source, a bulb-type LED lamp including an LED as a light source has been spreading. The LED lamp incorporates a substrate mounted with the LED functioning as the light source. Since the LED functioning as the light source is mounted on one side of the flat substrate, with the situation as it is, a luminous intensity distribution angle does not expand to an angle equal to or larger than 180 degrees. Light emitted by the LED has stronger directivity than light emitted by the filament of the incandescent lamp. Therefore, the center of an irradiation field irradiated by the LED lamp is felt bright and the periphery of the irradiation field is felt dark.

In order to improve a luminous intensity distribution characteristic, there have been developed an LED lamp in which a substrate tilted sideward is added to increase a luminous intensity distribution amount spreading to the periphery and an LED lamp incorporating an optical element or a reflection plate.

### BRIEF DESCRIPTION OF THE DRAWINGS

FIG. 1 is a perspective view of a partially cut-out LED lamp in an embodiment;

FIG. 2 is an exploded perspective view of the LED lamp shown in FIG. 1;

FIG. 3 is a sectional view of the LED lamp shown in FIG. 1; and

FIG. 4 is an enlarged sectional view of a joining section of a globe and a housing shown in FIG. 3.

### DETAILED DESCRIPTION

In general, according to one embodiment, there is provided an LED lamp including: an LED module in which a plurality of LEDs are arranged in a ring shape and mounted on a substrate; a base body configured to hold the LED module; a first globe arranged to surround an outer circumference of the substrate, a bore diameter of a first joining end of the first globe extending to an emission side of the LEDs being larger than a bore diameter of an attachment section fixed to the base body; a second globe including a second joining end attached to the first joining end and configured to cover the emission side of the LEDs; and a light guide body including a proximal end fixed to a side where the LEDs are arranged and a distal end section having a diameter larger than the bore diameter of the attachment section of the first globe.

In the LED lamp, the light guide body may warp to an outer circumferential side of the substrate from the proximal end to the distal end section, and the distal end section may be arranged further on the substrate side than the first joining end.

In the LED lamp, the light guide body may include an incident section configured to cover at least a part of the emission side of the LEDs.

In the LED lamp, the distal end section of the light guide body may have an outer diameter larger than a circle circumscribing the substrate.

In the LED lamp, the distal end section of the light guide body may have an outer diameter larger than an outer diameter of a seat of the base body for holding the substrate.

In the LED lamp, the attachment section of the first globe may be fixed to the base body in a position further retracted than the substrate with respect to a direction in which the LEDs emit lights.

In the LED lamp, the first joining end of the first globe and the second joining end of the second globe may have an outer diameter larger than an outer diameter of the distal end section of the light guide body.

In the LED lamp, the first joining end may include a concave section in a position in a center in a thickness direction in which lights emitted from the LEDs are transmitted, the second joining end may include a convex section corresponding to the concave section, and the concave section and the convex section may be fit with each other.

In general, according to other embodiment, there is provided an LED lamp including: an LED module in which a plurality of LEDs are arranged in a ring shape and mounted on a substrate; a base body configured to hold the LED module and thermally connected to the LED module; a first globe arranged to surround an outer circumference of the substrate, a bore diameter of a first joining end of the first globe extending to an emission side of the LEDs being larger than a bore diameter of an attachment section fixed to the base body; a second globe including a second joining end attached to the first joining end and configured to cover the emission side of the LEDs; a light guide body including a proximal end fixed to a side where the LEDs are arranged and a distal end section having a diameter larger than the bore diameter of the attachment section of the first globe and arranged further on the substrate side than the first joining end; and fins including, at ends on the substrate side, inclined sections arranged perpendicularly to the substrate in an outer circumference of the base body and formed to be reduced in height toward the substrate, the fins radiating heat generated by the LEDs.

In the LED lamp, the first globe may include an outer peripheral wall extending along a conical surface that passes tops of the fins.

LED lamps according to embodiments are explained in detail below with reference to the drawings. In the embodiments, components having the same functions are denoted by the same reference numerals and signs and redundant explanation of the components is omitted.

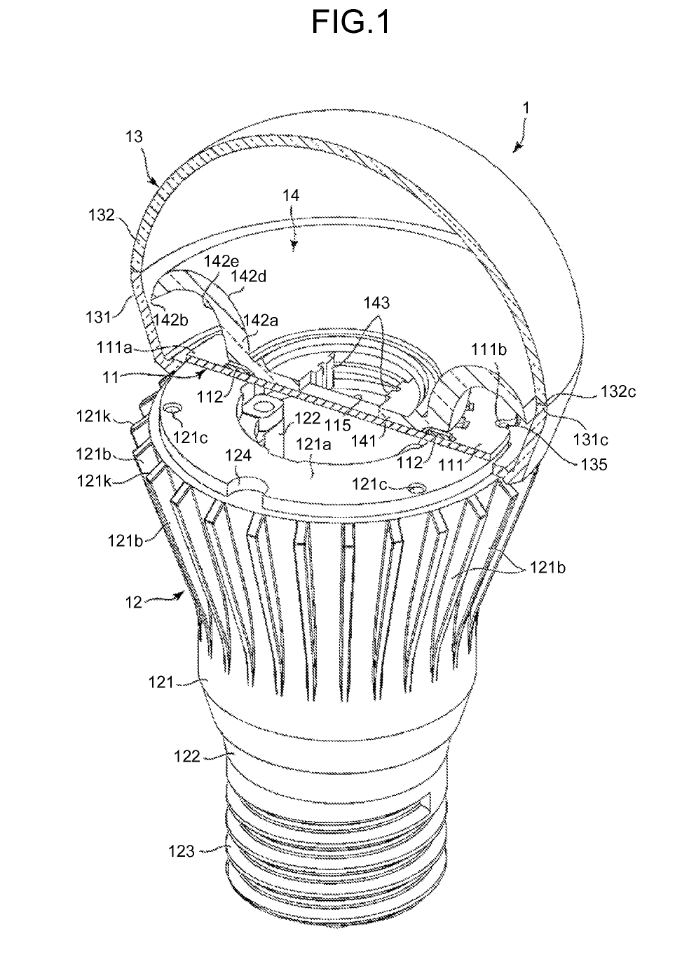

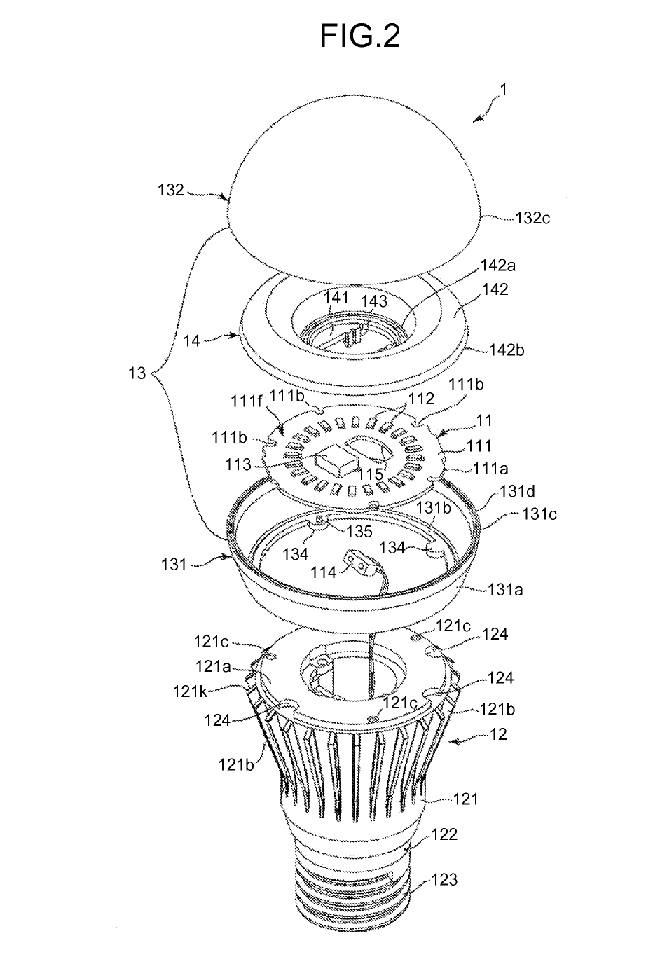

An LED lamp 1 in an embodiment is explained with reference to FIGS. 1 to 4. The LED lamp 1 shown in FIG. 1 is an LED lamp having an appearance of a so-called bulb type. In this specification, an “LED” includes a light-emitting device besides a light-emitting diode. The LED lamp 1 includes an LED module 11, a base body 12, a globe 13 and a light guide body 14 shown in FIG. 2. The globe 13 is formed to be divided into a first globe 131 and a second globe 132 by a surface parallel to a substrate 111 of the LED module 11 in a portion where the outer diameter of the globe 13 is the largest.

The LED module 11 includes, as shown in FIG. 2, a substrate 111 formed in a circular disk shape, at least one LED 112 mounted on the substrate, a connector 113 arranged in the center of the substrate 111 in order to supply electric power to the LED, and an opening section 115 for allowing a plug 114 connected to the connector to pass. In this embodiment, as shown in FIG. 2, twenty-four LEDs 112 are arranged at equal intervals on the same circle with respect to the center of the substrate 111. Note that, in this specification, a center axis of the LED lamp 1 passing the center of the circle formed by the LEDs 112 is sometimes simply referred to as “center” or “center axis”.

The connector 113 is attached to a position eccentric from the center of the substrate 111 further on the inner side than the LEDs 112 arranged in a ring shape. The opening section 115 is provided in the vicinity of a position where the connector 113 is attached. The plug 114 is connected to a control substrate arranged on the inside of the base body 12. A power supply circuit and a lighting circuit are provided on the control substrate.

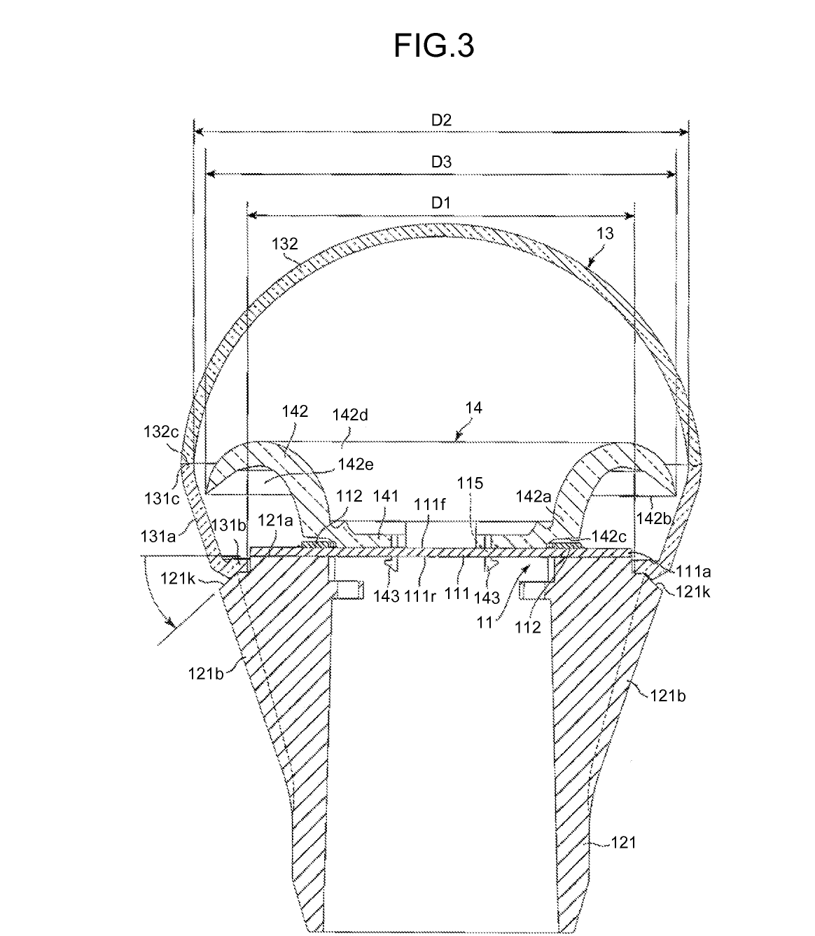

The base body 12 holds the LED module 11 as shown in FIG. 3. The base body 12 includes, as shown in FIG. 2, a thermal radiator 121, an insulating material 122 and a cap 123. The thermal radiator 121 is manufactured by die casting from a material excellent in heat conductivity, in this embodiment, an aluminum alloy. The thermal radiator 121 includes a contact surface 121a thermally connected to the LED module 11. The contact surface 121a includes at least a region that is in contact with the substrate 111 in a range in which the LEDs 112 are mounted.

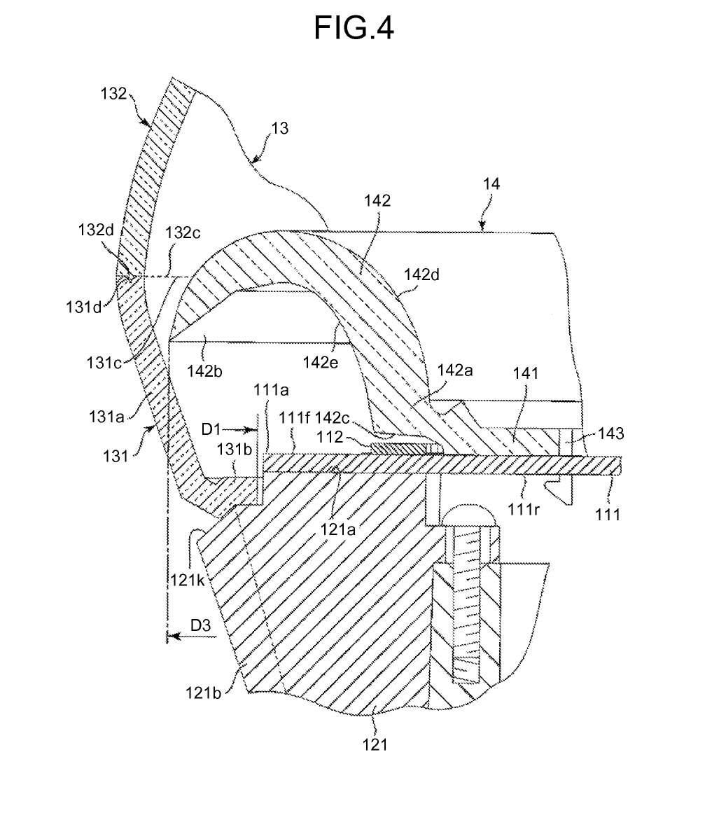

The thermal radiator 121 includes, on the outer side surface, fins 121b for radiating heat generated by the LEDs 112. Each of the fins 121b is arranged perpendicularly to the substrate 111. A plurality of the fins 121b are provided at equal intervals in the circumferential direction with respect to the center axis of the LED lamp 1. The fins 121b include inclined sections 121k of the fins 121b at ends on the substrate 111 side. The inclined sections 121k are formed to be reduced in the height of the fins 121b toward the substrate 111. That is, the ends of the fins 121b are formed to tilt along a conical surface expanding toward the cap 123 side with respect to a surface parallel to the substrate 111. Besides being formed in a linear shape like the inclined sections 121k, the ends of the fins 121b may be formed in an arc such that the corners of the ends are rounded. Since the inclined sections 121k are formed at the ends of the fins 121b, as shown in FIGS. 3 and 4, V-shaped gaps are formed between the ends of the fins 121b and the first globe 131.

The insulating material 122 is formed of a nonconductive member such as synthetic resin, inserted into the thermal radiator 121, and fixed to the thermal radiator 121 by screws. The control substrate for controlling lighting and extinction of the LEDs 112 is held on the inside of the insulating material 122. The cap 123 is formed to match a screw-type socket for an incandescent lamp and insulated from the thermal radiator 121 by the insulating material 122. The cap 123 is connected to the control substrate.

As shown in FIGS. 1 to 4, the globe 13 is formed to be divided into the first globe 131 and the second globe 132. The first globe 131 is arranged to surround the outer circumference of the substrate 111 of the LED module 11. The first globe 131 includes an outer peripheral wall 131a extending along a conical surface, which passes the tops of the fins 121b of the thermal radiator 121, a flange 131b extending to the inner side in parallel to the contact surface 121a and fixed to the thermal radiator 121, and a first joining end 131c formed by extending the outer peripheral wall 131a to the emission side of the LEDs 112. The flange 131b functioning as an attachment section includes fitting tabs 134 further extending to the inner side.

At least one, in this embodiment, four fitting tabs 134 are provided. Fitting sections 124 are formed in the thermal radiator 121 in parts corresponding to positions where the fitting tabs 134 are provided. The fitting sections 124 protrude further to the inner side than the outer circumferential edge of the substrate 111. The fitting tabs 134 are attached to the fitting sections 124 to thereby being sandwiched between the outer circumferential edge of the substrate 111 and the thermal radiator 121. Therefore, steps having a dimension slightly larger than the thickness of the flange 131b are provided between the contact surface 121a and portions where the flange 131b is fixed. That is, the flange 131b of the first globe 131 is fixed to the thermal radiator 121 of the base body 12 in a position further retracted than the substrate 111 with respect to a direction in which the LEDs 112 emit lights.

Pins 135 for determining positions relative to the substrate 111 are formed in several ones of the fitting tabs 134. The pins 135 fit with notches 111b formed at the outer circumferential edge of the substrate 111. The thermal radiator 121 includes, in places other than places where the fitting tabs 134 are arranged, holes 121c for screwing the substrate 111.

As shown in FIGS. 3 and 4, a bore diameter D1 at the inner circumferential edge of the flange 131b, which is the attachment section of the first globe 131, is slightly larger than the outer circumferential diameter of the substrate 111. Therefore, the substrate 111 uniformly comes into contact with the contact surface 121a of the thermal radiator 121 to the outer circumferential edge of the substrate 111 without being caught by the flange 131b of the first globe 131. Since the flange 131b is formed toward the center and the outer peripheral wall 131a expands along the conical surface from the flange 131b to the first joining end 131c, naturally, a bore diameter D2 of the first joining end 131c of the first globe 131 is larger than the bore diameter D1 of the flange 131b.

The second globe 132 includes a second joining end 132c connected to the first joining end 131c. The second globe 132 is formed in a dome shape that covers the emission side of the LEDs 112. As shown in FIG. 3, the second globe 132 is formed along a spherical surface having a substantially fixed curvature. In the case of this embodiment, the second globe 132 is a spherical surface slightly smaller than a hemisphere. The second globe 132 is made of synthetic resin by injection molding. Therefore, depending on a material and a manufacturing process, the second globe 132 may be equal to or larger than a hemisphere integrally molded to a position exceeding a great circle.

The first joining end 131c of the first globe 131 and the second joining end 132c of the second globe 132 are fused by ultrasonic joining, which is an example of fused junction. The first joining end 131c and the second joining end 132c may be fused by laser joining instead of the ultrasound joining. In both the cases, since the first joining end 131c and the second joining end 132c are melted together and joined, light transmitted through a portion of the joining is not refracted or reflected. Unevenness less easily occurs in brightness.

As shown in FIG. 4, the first joining end 131c includes a concave section 131d in a position in the center in the thickness direction in which light emitted from the LED 112 is transmitted. The second joining end 132c includes a convex section 132d corresponding to the concave section 131d. The convex section 132d projects more largely than the depth of the concave section 131d and has a volume same as the capacity of the concave section 131d. In a state in which the first joining end 131c and the second joining end 132c are matched to be joined, the convex section 132d bumps against the bottom of the concave section 131d and a gap is formed. However, since the capacity of the concave section 131d and the convex section 132d are substantially the same, the first joining end 131c and the second joining end 132c are joined without a gap by being fused.

The light guide body 14 includes, as shown in FIGS. 1 and 3, a base section 141, a light guide section 142 and hooks 143. As shown in FIGS. 1 and 3, in a portion excluding ranges of the connector 113 and the opening section 115 in a range on the inner side of the LEDs 112 arranged in the ring shape, the base section 141 is in contact with a front surface 111f of the substrate 111 on which the LEDs 112 are arranged. The light guide section 142 includes a proximal end 142a and a distal end section 142b. The proximal end 142a is integrally connected to a corner portion of the outer circumference of the base section 141. An incident section 142c is formed to cover at least a part, in this embodiment, substantially the entire surface of the emission side of the LEDs 112.

As shown in FIGS. 1, 3 and 4, the light guide section 142 of the light guide body 14 is warped to the outer circumferential side of the substrate 111 from the proximal end 142a to the distal end section 142b. The light guide section 142 extends in an emission direction from the proximal end 142a and is gently folded back around a place beyond the first joining end 131c. The distal end section 142b is located further on the substrate 111 side than the first joining end 131c.

The distal end section 142b, which is an outermost diameter portion of the light guide body 14, has an outer diameter larger than the bore diameter D1 of the flange 131b, which is an attachment section of the first globe 131. Therefore, the outer diameter is larger than a circle circumscribing the substrate 111 and is larger than the contact surface 121a of the thermal radiator 121 that holds the substrate 111. In this embodiment, as shown in FIGS. 3 and 4, an outer diameter D3 of the distal end section 142b of the light guide body 14 is formed larger than the outer diameter of the thermal radiator 121 of the base body 12 and a circle circumscribing the tops of the fins 121b. Note that, since the globe 13 covers the light guide body 14, the bore diameter D2 of the first joining end 131c of the first globe 131 and a bore diameter of the second joining end 132c of the second globe 132 are larger than the outer diameter D3 of the distal end section 142b of the light guide body 14.

As shown in FIGS. 3 and 4, the hooks 143 are formed in series in the base section 141 in a position corresponding to the edge of the opening section 115 of the substrate 111. The hooks 143 extend through the opening section 115 from the front surface 111f to the rear surface 111r of the substrate 111. The hooks 143 hold the light guide body 14 on the substrate 111. Note that, instead of providing the hooks 143, the base section 141 may be bonded and fixed to the front surface 111f of the substrate 111 or may be fastened by screws, rivets, or the like.

In the LED lamp 1 configured as explained above, after the thermal radiator 121, the insulating material 122, the control substrate and the cap 123 are combined as the base body 12, the first globe 131 is attached to the end of the thermal radiator 121 on a far side from the cap 123. The LED module 11 is fixed by screws or the like to hold the fitting tabs 134 of the first globe 131. The plug 114 is connected to the connector 113. After the light guide body 14 is attached using the opening section 115 of the substrate 111, finally, the second globe 132 is attached to the first globe by the ultrasonic joining.

A first side surface 142d, which is the inner circumferential side in the proximal end 142a, is equivalent to the outer surface of a torus. A second side surface 142e, which is the outer circumferential side in the proximal end 142a, is equivalent to the inner surface of the torus. Lights emitted from the LEDs 112 enter the light guide section 142 from the incident section 142c. A part of the lights is emitted from the first side surface 142d and the second side surface 142e between the incident section 142c and the distal end section 142b. The remaining lights guided to the distal end section 142b of the light guide section 142 are emitted from the distal end section 142b toward the rear surface 111r side from the front surface 111f side across an outer circumferential section 111a of the substrate 111. Processing for efficiently emitting light, unevenness processing, or the like may be applied to the first side surface 142d and the second side surface 142e.

The outer diameter D3 of the distal end section 142b of the light guide body 14 is larger than the outer diameter of the base body 12 excluding the fins 121b. In this embodiment, as shown in FIGS. 3 and 4, the distal end section 142b is located further on the outer circumferential side than the tops of the fins 121b. Therefore, lights emitted from the distal end section 142b of the light guide body 14 are widely emitted to the rear surface 111r side of the substrate without being blocked by the base body 12. Since the inclined sections 121k are provided at the ends of the fins 121b, shadows of the fins 121b are not formed by the lights emitted from the distal end section 142b of the light guide body 14.

The distal end section 142b of the light guide body 14 is located further on the substrate 111 side than a position where the first joining end 131c and the second joining end 132c are fused. Lights emitted from the distal end section 142b to the rear surface 111r side of the substrate are transmitted through the outer peripheral wall 131a of the first probe 131. Since the outer peripheral wall 131a is formed along the conical surface, which passes the tops of the fins 121b, the outer peripheral wall 131a is uniform with respect to the lights emitted from the distal end section 142b. Therefore, unevenness does not occur in the brightness of the light transmitted through the globe 13.

As explained above, in the LED lamp 1, since the globe 13 is formed in a divided structure of the first globe 131 and the second globe 132, the light guide body 14 having the outer diameter D3 larger than the bore diameter D1 of the attachment section for fixing the globe 13 to the base body 12 can be adopted and incorporated in the globe 13. As a result, the lights emitted from the LEDs 112 can also be distributed to the rear surface 111r side of the substrate of the LED module 11.

As explained above, in the embodiments, an LED lamp having a large luminous intensity distribution angle is provided by adopting a light guide body having an outer diameter larger than the bore diameter of an attachment section of a globe.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An LED lamp comprising:
an LED module in which a plurality of LEDs are arranged in a ring shape and mounted on a substrate;
a base body configured to hold the LED module;
a first globe arranged to surround an outer circumference of the substrate, a bore diameter of a first joining end of the first globe extending to an emission side of the LEDs being larger than a bore diameter of an attachment section fixed to the base body;
a second globe including a second joining end attached to the first joining end and configured to cover the emission side of the LEDs; and
a light guide body including a proximal end fixed to a side where the LEDs are arranged and a distal end section having a diameter larger than the bore diameter of the attachment section of the first globe.

2. The LED lamp according to claim 1, wherein
the light guide body warps to an outer circumferential side of the substrate from the proximal end to the distal end section, and
the distal end section is arranged further on the substrate side than the first joining end.

3. The LED lamp according to claim 1, wherein the light guide body includes an incident section configured to cover at least a part of the emission side of the LEDs.

4. The LED lamp according to claim 1, wherein the distal end section of the light guide body has an outer diameter larger than a circle circumscribing the substrate.

5. The LED lamp according to claim 1, wherein the distal end section of the light guide body has an outer diameter larger than an outer diameter of a seat of the base body for holding the substrate.

6. The LED lamp according to claim 1, wherein the attachment section of the first globe is fixed to the base body in a position further retracted than the substrate with respect to a direction in which the LEDs emit lights.

7. The LED lamp according to claim 1, wherein the first joining end of the first globe and the second joining end of the second globe have an outer diameter larger than an outer diameter of the distal end section of the light guide body.

8. The LED lamp according to claim 1, wherein
the first joining end includes a concave section in a position in a center in a thickness direction in which lights emitted from the LEDs are transmitted,
the second joining end includes a convex section corresponding to the concave section, and
the concave section and the convex section are fit with each other.

9. An LED lamp comprising:
an LED module in which a plurality of LEDs are arranged in a ring shape and mounted on a substrate;
a base body configured to hold the LED module and thermally connected to the LED module;
a first globe arranged to surround an outer circumference of the substrate, a bore diameter of a first joining end of the first globe extending to an emission side of the LEDs being larger than a bore diameter of an attachment section fixed to the base body;
a second globe including a second joining end attached to the first joining end and configured to cover the emission side of the LEDs;
a light guide body including a proximal end fixed to a side where the LEDs are arranged and a distal end section having a diameter larger than the bore diameter of the attachment section of the first globe and arranged further on the substrate side than the first joining end; and
fins including, at ends on the substrate side, inclined sections arranged perpendicularly to the substrate in an outer circumference of the base body and formed to be reduced in height toward the substrate, the fins radiating heat generated by the LEDs.

10. The LED lamp according to claim 9, wherein the first globe includes an outer peripheral wall extending along a conical surface that passes tops of the fins.
